(19) United States
(12) Patent Application Publication
(10) Pub. No.: US 2020/0126000 A1
(43) Pub. Date: Apr. 23, 2020

(54) CAR SHARING SERVICE APPARATUS AND METHOD FOR OPERATING THE SAME

(71) Applicants: HYUNDAI MOTOR COMPANY, Seoul (KR); KIA MOTORS CORPORATION, Seoul (KR)

(72) Inventor: Chi Hwan KIM, Seongnam-si (KR)

(21) Appl. No.: 16/274,586

(22) Filed: Feb. 13, 2019

(30) Foreign Application Priority Data
Oct. 23, 2018 (KR) 10-2018-0126939

(51) Int. Cl. G06Q 10/02; G06Q 50/30; G07C 5/00

(52) U.S. Cl. CPC G06Q 10/02; G07C 5/008; G06Q 50/30

(57) ABSTRACT

A vehicle sharing service apparatus and a method for operating the same are provided. The vehicle sharing service apparatus may include a communication device to make communication with a user terminal and a vehicle terminal, a memory to store vehicle use history information related to each user, and a processor to recommend a vehicle having a function handling manner similar to a function handling manner of a vehicle, which is previously used, based on the vehicle use history information related to the user, when receiving a request for use of a vehicle sharing service of a user from the user terminal.

### CROSS-REFERENCE TO RELATED APPLICATION

The present application claims priority to Korean Patent Application No. 10-2018-0126939, filed on Oct. 23, 2018, the entire contents of which is incorporated herein for all purposes by this reference.

### BACKGROUND OF THE INVENTION

### Field of the Invention

The present invention relates to a vehicle sharing service apparatus and a method for operating the same.

### Description of Related Art

Car sharing is a system allowing a user to rent and use a vehicle in the unit of time. When such a vehicle sharing system is used, the user makes a reservation for a vehicle, receives the vehicle at a place close to the user, utilizes the vehicle, and then returns the vehicle to a person in charge.

Although a conventional vehicle sharing system allows the user to easily make a reservation for a vehicle to be used through an electronic device of the user, the user is able to recognize only a vehicle type and/or a vehicle color, but unable to recognize vehicle functions and vehicle handling manners in advance. Accordingly, when a vehicle, which is mainly used by the user, and a rent vehicle are different from each other in functions and function handling manners, the user may be bothered because the user has to recognize vehicle functions and vehicle handling manners through a guide (manual).

The information included in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a vehicle sharing service apparatus and a method for operating the same, configured for recommending, to a user using a vehicle sharing service, a vehicle having function handling manners similar to those of a vehicle which is conventionally mainly used by the user.

Various aspects of the present invention are directed to providing a vehicle sharing service apparatus and a method for operating the same, configured for providing a manual about function handling manners of a present vehicle to be used by a user using the vehicle sharing service, which are different from function handling manners of a vehicle conventionally mainly used by the user.

The technical problems to be solved by the present invention are not limited to the aforementioned problems, and any other technical problems not mentioned herein will be clearly understood from the following description by those skilled in the art to which the present invention pertains.

According to various aspects of the present invention, a vehicle sharing service apparatus may include a communication device to make communication with a user terminal and a vehicle terminal, a memory to store vehicle use history information related to each user, and a processor to recommend a vehicle having a function handling manner similar to a function handling manner of a vehicle, which is previously used, based on the vehicle use history information related to the user, when receiving a request for use of a vehicle sharing service of a user from the user terminal.

The vehicle use history information related to the user may include user identification information, a use date, a vehicle number, a vehicle type and a vehicle handling history.

The vehicle handling history may include at least one piece of vehicle handling information including a vehicle function, an operator type, an operator position, and an operator handling manner.

The vehicle handling information is implemented with a vector value of each function defined based on the operator position.

The vehicle handling information is implemented with a vector value of each function defined based on the operator handling manner.

The processor generates user function handling information by clustering vehicle handling information associated with at least one function used in the previously used vehicle, based on the vehicle use history information related to the user.

The processor determines similarity between the user function handling information and function handling information related to each vehicle, which is stored in the memory, and recommends a vehicle mapped to vehicle function handling information having similarity equal to or greater than a threshold value.

The processor adjusts a weight of each function based on at least one of use frequency of the function by the user or environment information related to the function.

The processor extracts different vehicle function handling information between the user function handling information and the vehicle function handling information related to the recommended vehicle, generates a user customized manual based on the extracted different vehicle function handling information, and transmits the user customized manual to the vehicle terminal.

The vehicle terminal outputs a tip for a function handling manner different from the function handling manner of the vehicle, which is previously used, based on the user customized manual, when it is detected that the user gets on the vehicle.

Meanwhile, according to various aspects of the present invention, a method for operating a vehicle sharing service apparatus, may include receiving, by the vehicle sharing service apparatus, vehicle handling information from a vehicle terminal and storing vehicle use history information related to a user, receiving, by the vehicle sharing service apparatus, a request for use of a vehicle sharing service by the user from a user terminal, and recommending, by the vehicle sharing service apparatus, a vehicle having a function handling manner similar to a function handling manner of a vehicle, which is previously used, based on the vehicle use history information related to the user.

The vehicle use history information related to the user may include user identification information, a use date, a vehicle number, a vehicle type and a vehicle handling history.

The vehicle handling history may include at least one piece of vehicle handling information including a vehicle function, an operator type, an operator position, and an operator handling manner.

The vehicle handling information is implemented with a vector value of each function defined based on the operator position.

The vehicle handling information is implemented with a vector value of each function defined based on the operator handling manner.

The recommending of the vehicle may include creating, by the vehicle sharing service apparatus, user function handling information by clustering vehicle handling information associated with at least one function used in the previously used vehicle, based on the vehicle use history information related to the user, comparing, by the vehicle sharing service apparatus, the user function handling information with function handling information related to each vehicle, which is previously stored, and recommending, by the vehicle sharing service apparatus, at least one vehicle based on a comparison result.

The comparing of the user function handling information with the previously stored function handling information may include determining, by the vehicle sharing service apparatus, similarity between the user function handling information and the previously stored function handling information related to each vehicle, by adjusting a weight of each function based on at least one of use frequency of the function by the user or environment information related to the function.

The recommending of the at least one vehicle may include recommending, by the vehicle sharing service apparatus, a vehicle mapped to vehicle function handling information having similarity equal to or greater than a threshold value.

The method may further include selecting, by the vehicle sharing service apparatus, one from among recommended vehicles to make a reservation for the one, extracting, by the vehicle sharing service apparatus, different vehicle function handling information between the function handling information related to the vehicle subject to the reservation and the user function handling information, and creating, by the vehicle sharing service apparatus, a user customized manual based on the extracted different vehicle function handling information to transmit the user customized manual to the vehicle terminal, after the recommending of the vehicle.

The vehicle terminal outputs a tip for a function handling manner different from the function handling manner of the vehicle, which is previously used, based on the user customized manual, when it is detected that the user gets on the vehicle.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view exemplarily illustrating a vehicle sharing service system, according to an exemplary embodiment of the present invention;

FIG. 2 is a block diagram of a vehicle terminal illustrated in FIG. 1;

FIG. 3 is a block diagram of a vehicle sharing device illustrated in FIG. 1;

FIG. 4 is a flowchart illustrating a method for operating the vehicle sharing device, according to an exemplary embodiment of the present invention; and

FIG. 5 is a flowchart illustrating a method for extracting different function handling information illustrated in FIG. 4.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter, embodiments of the present invention will be described in detail with reference to accompanying drawings. In the following description, the same reference numerals will be assigned to the same components even though the components are illustrated in different drawings. Furthermore, in the following description of an exemplary embodiment of the present invention, a detailed description of well-known features or functions will be ruled out in order not to unnecessarily obscure the gist of the present invention.

In describing components of exemplary embodiments of the present invention, the terms 1^{st} 2^{nd} first, second, A, B, (a), (b), and the like may be used herein. These terms are only used to distinguish one component from another component, but do not limit the corresponding components irrespective of the order or priority of the corresponding components. Unless otherwise defined, all terms used herein, including technical or scientific terms, have the same meanings as those generally understood by those skilled in the art to which the present invention pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

The present invention relates to a technology of providing a manual about function handling manners of a present vehicle to be used by a user using the vehicle sharing service, which are different from function handling manners of a vehicle previously mainly used by the user, and recommending, to the user, a vehicle having function handling manners similar to those of the vehicle previously mainly used by the user. In other words, according to an exemplary embodiment of the present invention, values for a vehicle function handling manners are defined depending on functions of operators in a vehicle and the positions of the operators, a vehicle having similar handling manners is extracted based on the similarity of the values, the vehicle is recommended based on extracted information, and a handling manner information different from that of a previous vehicle is provided for a user, increasing the productivity of a shared vehicle.

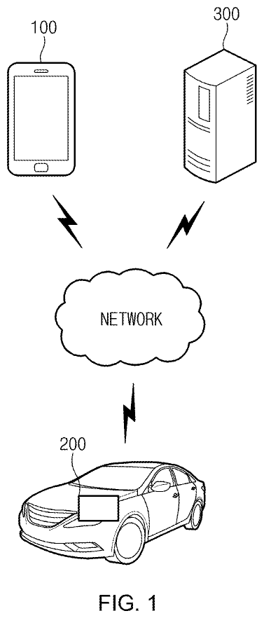

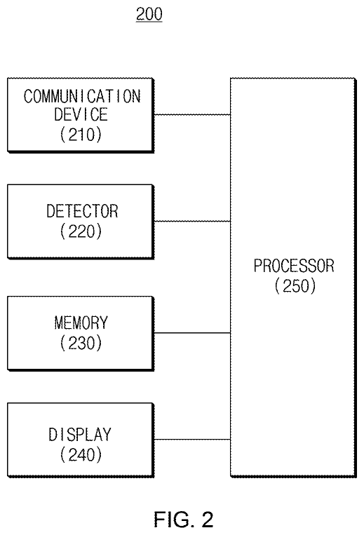

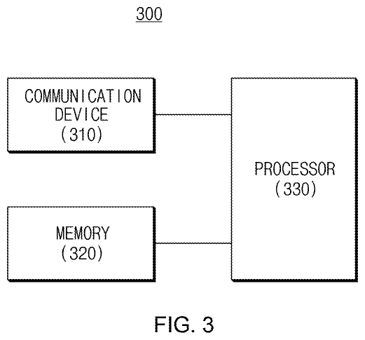

FIG. 1 is a view exemplarily illustrating a vehicle sharing service system, according to an exemplary embodiment of the present invention, FIG. 2 is a block diagram of a vehicle terminal illustrated in FIG. 1, and FIG. 3 is a block diagram of a vehicle sharing device illustrated in FIG. 1.

Referring to FIG. 1, the vehicle sharing service system includes a user terminal 100 connected through a network, a vehicle terminal 200, and a vehicle sharing service device 300 (hereinafter, referred to as a “service device”). In the instant case, the network may be implemented with a wireless Internet network, a mobile communication network, and/or a short-range wireless communication network.

The user terminal 100, which is an electronic device of a user using a vehicle sharing service, may include a smartphone, a tablet, a laptop computer and/or a desktop computer. Although the user terminal 100 is not illustrated, the user terminal 100 may include a communication module to communicate with the vehicle terminal 200 and/or the service device 300, a user input module for the input of a user, an output module for information output, a memory, and a processor.

The user terminal 100 executes an application previously installed in the user terminal 100 and provided for the use of the vehicle sharing service depending on a user input. The user terminal 100 transmits, to the service device 300, the request (hereinafter, referred to as “service request”) for the use of the vehicle sharing service through the executed application.

The user terminal 100 makes a reservation for a vehicle to be rented through the service request and receives an authentication key (authentication information) for the use of the reserved vehicle from the service device 300. The user terminal 100 receives the authentication key transmitted from the service device 300 and stores the authentication key in a memory. The user terminal 100 undergoes a user authentication process of the vehicle terminal 200 mounted in the reserved vehicle by use of the authentication key.

The user terminal 100 may perform a vehicle control operation, such as vehicle door unlocking/locking and emergency light ON/OFF using a smart key provided by the application, when the user authentication process is completed.

The vehicle terminal 200 detects information (handling information) for handling a specific function of a vehicle when a user using the vehicle handles the specific function. The vehicle terminal 200 transmits the detected handling information related to the specific function to the service device 300.

Referring to FIG. 2, the vehicle terminal 200 includes a communication device 210, a detector 220, a memory 230, a display 240, and a processor 250.

The communication device 210 supports the wireless communication of the mobile terminal 100 and/or the service device 300. Wireless communication technologies may include wireless Internet technologies, such as Wireless LAN (WLAN; WiFi), wireless broadband (Wibro) and World Interoperability for Microwave Access (Wimax), short-range communication technologies, such as Bluetooth, Near Field Communication (NFC), Radio Frequency Identification (RFID), infrared data association (IrDA), and ZigBee, and/or mobile communication technologies such as Code Division Multiple Access (CDMA), Global System for Mobile Communication (GSM), Long Term Evolution (LTE), and LTE-Advanced.

The communication device 210 may perform wired communication by use of wired Internet technologies such as a local area network (LAN), a wide area network (WAN), the Ethernet and/or an integrated services digital network (ISDN) and/or a serial communication technology such as a universal serial bus (USB).

The detector 220 detects information on vehicle handling by the user, in other words, when a user operates an operator having a specific function to handle the specific function (e.g., locking a door, opening a trunk, or turning on a fog lamp).

In the instant case, the operator is a user interface which is handled by the user such that the user controls the handling of a function of the vehicle. The operator may include a door locking/unlocking button, a windshield opening/closing switch, a sunroof switch, a steering wheel height adjustment lever, a steering wheel heater button, an outdoor mirror control switch, a light switch, a wiper switch, an indoor circulation button, an external air inflow button, an air volume control knob, an air conditioning selection button, and/or an audio remote control. The vehicle handling information includes information on a vehicle function, the type of an operator, the position of the operator, and a handling manner. Positions of operators may be classified into a driver's door, a passenger's door, the left side of a steering wheel, the right side of the steering wheel, a steering wheel, a center fascia, a gear box, a seat bottom and inside box.

The detector 220 may detect vehicle handling information through vehicle sensors connected over an In-vehicle network (IVN) and electronic control units (ECU). The IVN is implemented with a controller area network (CAN), a medial oriented systems transport (MOST) network, a local interconnect network (LIN), and/or an X-by-wire (Flexray).

The memory 230 may store a program for the operation of the processor 250 and may temporarily store input/output data. The memory 230 may store the vehicle handling information detected by the detector 220. The memory 230 may store a vehicle function handling manual and a user customized manual. The vehicle function handling manual includes tips (description) on a handling manner of each function of the vehicle. The user customized manual includes tips (description) on a function and/or handling manner of the present vehicle used which is different from the vehicle mainly used by the user. The help included in the vehicle function handling manual and the user customized manual may be implemented in a form of a text, an image and/or a moving picture.

The memory 230 may be implemented with at least one of storage media (recording media) such as a flash memory, a hard disk, a Security Digital (SD) card, a Random Access Memory (RAM), a Static Random Access Memory (SRAM), a Read Only Memory (ROM), a Programmable Read Only Memory (PROM), an Electrically Erasable and Programmable ROM (EEPROM), an Erasable and Programmable ROM (EPROM), a register, a detachable disk, and a web storage.

The display 240 outputs information processed by the processor 250. The display 240 displays the vehicle function handling manual stored in the memory 230.

The display 240 may include at least one of a liquid crystal display (LCD), a thin film transistor-liquid crystal display (TFT LCD), an organic light-emitting diode (OLED) display, a flexible display, a 3D display, a transparent display, and a head-up display (HUD).

The display 240 may include an audio output module such as a speaker capable of outputting audio data. For example, the display 240 may display information for guiding the vehicle function handling manner and may output a voice signal (audio signal) through the speaker.

Furthermore, the display 240 may be implemented with a touchscreen coupled to a touch sensor and thus may be used as an input device as well as an output device. The touch sensor may include a touch film or a touch pad.

The processor 250 controls the overall operation of the vehicle terminal 200. The processor 250 may include at least one of an Application Specific Integrated Circuit (ASIC), a Digital Signal Processor (DSP), a Programmable Logic Devices (PLD), Field Programmable Gate Arrays (FPGAs), a Central Processing unit (CPU), microcontrollers, and microprocessors.

The processor 250 receives the authentication key transmitted from the service device 300 through the communication device 210 and stores the authentication key in the memory 230. The authentication key is used for identifying a user who makes the service request.

The processor 250 determines whether vehicle use is permitted to the user, based on whether the received authentication key is matched with an authentication key stored in the memory 230, when the authentication key is received from the user terminal 100. In other words, the processor 250 may permit for the vehicle use only when the received authentication key is matched with the stored authentication key.

The processor 250 controls the operation of the vehicle by controlling the ECU under a vehicle control command (e.g., door open), when the vehicle control command is received from the user terminal 100, after the vehicle use is permitted.

The processor 250 receives the user customized manual provided from the service device 300 through the communication device 210. The processor 250 determines whether the user takes the driver's seat, through the detector 220. The processor 250 outputs, onto the display 240, the user customized manual when it is determined that the user takes the driver's seat. In other words, the processor 250 outputs tips on the function handling manner of a present vehicle different from a previous vehicle which has been mainly used by the user such that the user fully understands the tips.

The processor 250 acquires the vehicle handling information through the detector 220 while the user is using the vehicle. The processor 250 detects the vehicle handing information used for executing a specific function of a vehicle when the specific function of the vehicle is executed as a user controls an operator. For example, when the user pushes upward a light switch to turn on a right turn signal lamp, the detector 220 detects, as vehicle handling information, a function (vehicle function) of turning on the right turn signal lamp, a light switch (the type of the operator, the left side (an operator position) of the steering wheel, and upward pushing (handling manner).

The processor 250 may store the detected vehicle handling information in the memory 230. The processor 250 may store the vehicle handling information as vector information. In the instant case, the processor 250 stores the vehicle handling information by referring to a predetermined vector value of each function and a vector value based on an operator position which is preset.

The processor 250 may transmit the vehicle handling information to the service device 300 at preset time intervals or may simultaneously transmit vehicle handling information collected at the time point that the user terminates the vehicle use. Furthermore, the processor 250 may transmit the vehicle handling information to the service device 300 in real time as soon as the vehicle handling information is detected.

The service device 300, which is a device to provide the vehicle sharing service, may be implemented in a form of a server. The service device 300 includes a communication device 310, a memory 320, and a processor 330 as illustrated in FIG. 3.

The communication device 310 may perform wired and/or wireless communication with the user terminal 100. The communication device 310 may perform wireless communication with the vehicle terminal 200. The communication device 310 transmits data (information) or receives data from the outside thereof depending on the instruction of the processor 330.

The memory 320 stores software programmed such that the processor 330 performs a preset operation. The memory 320 may store a vehicle use history of each user, function handling information related to each vehicle, and a similarity determination algorithm. The memory 320 may store vehicle sharing service subscriber information, vehicle sharing use registration information and/or vehicle information.

The memory 320 may be implemented with at least one of storage media (recording media) such as a flash memory, a hard disk, an SD card, an RAM, an SRAM, an ROM, a PROM, an EEPROM, an EPROM, a register, a detachable disk, and a web storage.

The processor 330 receives vehicle handling information related to a user transmitted from the vehicle terminal 200. The processor 330 generates vehicle use history information related to the user based on the received vehicle handling information related to the user and stores the vehicle use history information in the memory 320. The vehicle use history information related to the user includes user identification information, a use date, a vehicle (e.g., a vehicle number) to be used, a vehicle type (a vehicle model), and a vehicle handing history. The vehicle handling history information includes multiple pieces of vehicle handling information transmitted from the vehicle terminal 200.

The processor 330 extracts vehicle use history information related to a user who makes the service request from the memory 320, when the service request is received from the user terminal 100. The processor 330 extracts user function handling information based on the vehicle use history information related to the user.

The processor 330 extracts a vehicle model (vehicle) used by a user at the highest frequency, based on the vehicle use history information related to the user. The processor 330 generates user function handling information by extracting the vehicle handling information related to the functions of the vehicle used when the user utilizes the extracted vehicle model. Meanwhile, the processor 330 may generate user function handling information related to each vehicle used by the user.

The processor 330 defines, as one cluster information, at least one vehicle function(s) and an operator position corresponding to the at least one vehicle function, which are used when the vehicle is used, and stores the stored clustering information as one piece of data. For example, the processor 330 stores the clustering information, such as vehicle # N=(function 1, function 2, . . . , function N)=(position 1, position 2, . . . , position N), as one piece of data.

The processor 330 may define a vector value based on a position value in the cluster. For example, the processor 330 may generate data such as (function 1, function 2, . . . , function N)=(clustering position 1 detailed function 1, clustering position 1 detailed position 2, . . . , clustering position N detailed position N) and may store the data.

Meanwhile, the processor 330 may define a vector value through the classification based on the manner (handling manner) of handling the operator. In the instant case, the handling manners may be classified into switch position changing (e.g., such as wiper handling), toggling, pulling, pushing, and mode changing. When vehicle handling information is generated based on the handling manner of each function, the vehicle handling information may be generated in the form such as (function 1, function 2, . . . , and function N)=(handling manner 1, handling manner 2, . . . , and handling manner N).

The processor 330 extracts function handling information related to each vehicle from the memory 320, based on the extracted vehicle use history of the user. The function handling information related to each vehicle may include vehicle identification information (e.g., a vehicle model), a vehicle function, an operator type, an operator position, or an operator handling manner, and may include a function handling manual for each vehicle. The processor 330 extracts the function handling information related to each vehicle based on a function (s) included in the function handling information related to the user. For example, the processor 330 extracts function handling information, which is associated with light handling and wiper handling, of each vehicle if the user function handling information (light handling information, wiper handling information)=(10, 20).

The processor 330 compares the user function handling information with function handling information related to each vehicle. The processor 330 determines the similarity between the user function handling information and the function handling information related to the vehicle. In the instant case, the processor 330 determines the similarity between the user function handling information and the vehicle function handling information by use of a cosine similarity formula. Furthermore, the processor 330 may adjust the weight of each function based on at least one of the use frequency of each function by the user and environment information related to each function.

For example, a first vehicle has the function handling information=(the position of a light switch position, the position of a wiper switch)=(10, 20), when the light switch is positioned at the left side of a steering handle, and the wiper switch is positioned at the right side of the steering handle in the first vehicle. When the function handling information related to the second vehicle=(the position of a light switch, the position of a wiper switch)=(20, 10) as the positions of a light switch and a wiper switch are opposite to those of the first vehicle, the cosine similarity is determined to 0.2 which is quantitatively measured.

The processor 330 selects at least one vehicle having the similarity equal to or greater than a threshold value and recommends the vehicle to a user. In other words, the processor 330 extracts a vehicle having a function handling manner similar to a function handling manner of a vehicle (vehicle model) used by the user at the higher frequency of use. In the instant case, the processor 330 may extract a vehicle having a function handling manner similar to the function handling manner of the vehicle used by the user at the frequency of use, which is equal to or greater than a reference value, based on a vehicle handling history associated with the function of the vehicle used by the user at the frequency of use.

When any one of recommended vehicles is selected by the user, the processor 330 extracts the difference between function handling information related to the selected vehicle and the function handling information related to the vehicle used by the user at the higher frequency of use. The processor 330 generates a user customized manual based on the extracted difference. The processor 330 transmits the user customized manual to the vehicle terminal 200 when the reservation of the selected vehicle is completed.

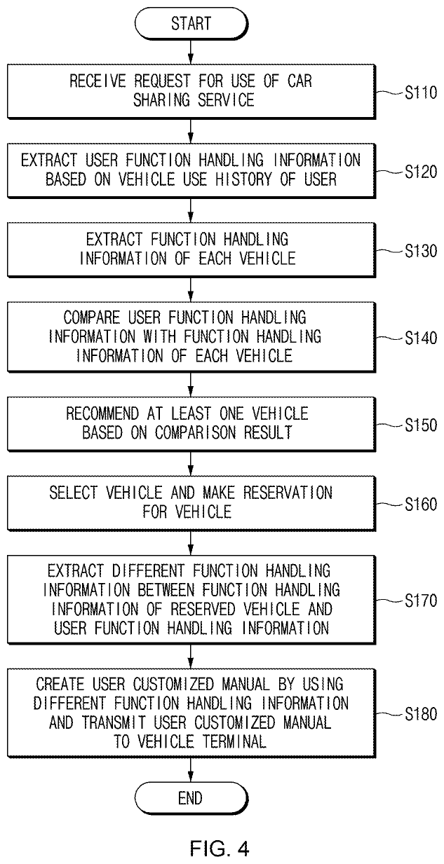

FIG. 4 is a flowchart illustrating a method for operating the vehicle sharing device, according to an exemplary embodiment of the present invention.

Referring to FIG. 4, the service device 300 receives a request (service request) for the use of a vehicle sharing service from the user terminal 100 (S110). The user terminal 100 is connected to the service device 300 through an application previously disposed in the user terminal 100. The user terminal 100 generates information on the service request based on a user input and transmits the information on the service request to the service device 300. The information on the service request includes user identification information, the period of use, the position for receiving the vehicle, and the position for returning the vehicle.

The service device 300 extracts function handling information related to a user, based on vehicle use history information related to the user making the service request (S120). The service device 300 extracts information (function handling information) on handling a function used by the user, based on a vehicle use history of the user. In the instant case, the service device 300 may generate the function handling information related to the user by extracting, based on the vehicle use history of the user, function handling information employed in a vehicle used by the user at the highest frequency of use.

The service device 300 extracts function handling information related to each vehicle based on the extracted function handling information related to the user (S130). In other words, the service device 300 extracts the function handling information related to each vehicle based on the vehicle use history information related to the user.

The service device 300 compares the function handling information related to the user with the function handling information related to each vehicle (S140). The service device 300 determines the function handling information related to the user and the function handling information related to each vehicle by use of a similarity determination algorithm or a cosine similarity formula stored in the memory 320.

The service device 300 recommends at least one vehicle having function handling information similar to the function handling information related to the user, based on the comparison result between the function handling information related to each vehicle and the function handling information related to the user (S150). The service device 300 selects a vehicle mapped to vehicle function handling information, the determined similarity of which is equal to or greater than a threshold value, and recommends the selected vehicle to the user. The service device 300 selects a vehicle having a function handling manner similar to a function handling manner of a vehicle mainly used by the user and transmits information on the selected vehicle to the user terminal 100 such that the selected vehicle is recommended to the user.

The service device 300 selects any one of vehicles recommended based on a user input and makes a reservation for the selected vehicle (S160).

The service device 300 extracts the difference between the function handling information for the reserved vehicle and the function handling information related to the user (S170).

The service device 300 generates a user customized manual by use of the extracted difference and transmits the user customized manual to the vehicle terminal 200 (S180). In the instant case, the service device 300 generates the user customized manual such that the user customized manual first provides tips for a function handling manner making a great difference from function handling manners of the vehicle mainly used by the user.

Thereafter, the vehicle terminal 200 outputs, onto the display 240, different function handling information by utilizing the user customized manual when the user making a reservation to use the vehicle sharing service gets on the vehicle.

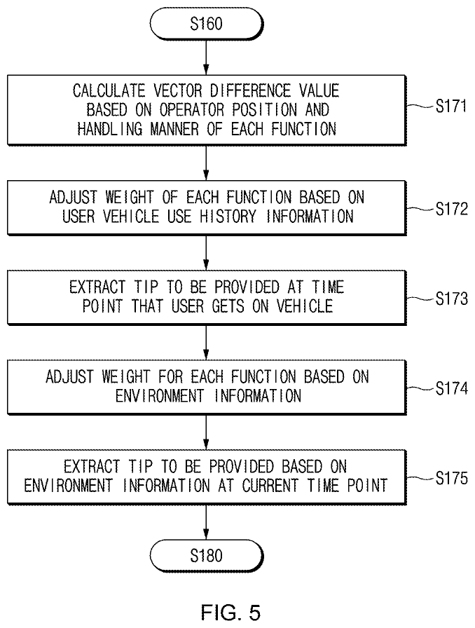

FIG. 5 is a flowchart illustrating a method for extracting different function handling information illustrated in FIG. 4.

The service device 300 compares the function handling information related to the user with the function handling information for the reserved vehicle to determine a difference value in an operator position vector value and/or a handling manner vector value (S171).

The service device 300 adjusts a weight of each function depending on the frequency of use by the user, based on the vehicle use history information related to the user (S172). The service device 300 applies the higher weight as the frequency of use by the user is increased.

The service device 300 extracts tips to be provided at a time point that the user gets on the vehicle, based on the determined difference value and the weight of each function (S173). In other words, the service device 300 finds out an item making a great difference in the position and the handling manner of an operator having a function representing the higher frequency of use by the user between the vehicle previously mainly used by the user and the reserved vehicle, and extracts the tips for the item.

The service device 300 adjusts the weight of each function depending on the frequency of use under an environment based on environment information (e.g., weather, the surroundings of a gas station) (S174). In other words, the service device 300 applies a higher weight to the information on handling a function used mainly by the user under similar environments.

The service device 300 extracts tips to be provided at a present time point, based on the environment information at the present time point (S175). The service device 300 finds out a function used above standard and making a great difference between the vehicle previously mainly used by the user and the reserved vehicle in terms of the position (function handling position) and the handling manner of an operator of the function, under the environment at the present time point and extracts the tips for the function.

As described above, according to an exemplary embodiment of the present invention, since the vehicle having the function handling manner similar to that of the vehicle, which is previously mainly used, is recommended to the user using the vehicle sharing service, the user may easily select the vehicle having functions easily handled and may make a reservation for the vehicle.

Furthermore, according to an exemplary embodiment of the present invention, when the function handling manner to be currently used by the user using the vehicle sharing service is different from the function handling manner of the vehicle, which is previously mainly used, the manual for the different function handling manner is provided. Accordingly, the user may conveniently use the relevant function even if the function handling manner of the vehicle to be used by the user is different from the function handling manner of the vehicle previously mainly used.

For convenience in explanation and accurate definition in the appended claims, the terms “upper”, “lower”, “inner”, “outer”, “up”, “down”, “upper”, “lower”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A vehicle sharing service apparatus comprising:
a communication device making communication with a user terminal and a vehicle terminal;
a memory of storing vehicle use history information related to each user; and
a processor configured to recommend a vehicle having a function handling manner similar to or a same as a function handling manner of a vehicle, which is previously used by a corresponding user, based on the vehicle use history information related to each user, when receiving a request for use of a vehicle sharing service of the corresponding user from the user terminal.

2. The vehicle sharing service apparatus of claim 1, wherein the vehicle use history information related to each user includes:
at least one of user identification information, a use date, a vehicle number, a vehicle type, and a vehicle handling history.

3. The vehicle sharing service apparatus of claim 2, wherein the vehicle handling history includes:
at least one piece of vehicle handling information including a vehicle function, an operator type, an operator position, and an operator handling manner.

4. The vehicle sharing service apparatus of claim 3, wherein the vehicle handling information is implemented with a vector value of each function defined based on the operator position.

5. The vehicle sharing service apparatus of claim 3, wherein the vehicle handling information is implemented with a vector value of each function defined based on the operator handling manner.

6. The vehicle sharing service apparatus of claim 3, wherein the processor is configured to generate user function handling information by clustering vehicle handling information associated with at least one function used in the vehicle previously used by the corresponding user, based on vehicle use history information related to the corresponding user.

7. The vehicle sharing service apparatus of claim 6, wherein the processor is configured to:
determine similarity between a generated user function handling information and function handling information related to each vehicle, which is stored in the memory; and
recommend a vehicle mapped to vehicle function handling information having the similarity which is equal to or greater than a predetermined threshold value.

8. The vehicle sharing service apparatus of claim 7, wherein the processor is configured to adjust a weight of each function based on at least one of use frequency of the at least one function by the user or environment information related to the at least one function.

9. The vehicle sharing service apparatus of claim 8, wherein the processor is configured to:
extract different vehicle function handling information related to a difference between the generated user function handling information and vehicle function handling information related to a recommended vehicle;
generate a user customized manual based on extracted different vehicle function handling information; and
transmit a generated user customized manual to the vehicle terminal.

10. The vehicle sharing service apparatus of claim 9, wherein the vehicle terminal outputs a tip for a function handling manner different from the function handling manner of the vehicle, which is previously used by the corresponding user, based on the generated user customized manual, when the corresponding user is detected to get on the recommended vehicle.

11. A method for operating a vehicle sharing service apparatus, the method comprising:
receiving, by the vehicle sharing service apparatus, vehicle handling information from a vehicle terminal and storing vehicle use history information related to a user;
receiving, by the vehicle sharing service apparatus, a request for use of a vehicle sharing service by the user from a user terminal; and
recommending, by the vehicle sharing service apparatus, a vehicle having a function handling manner similar to or equal to a function handling manner of a vehicle, which is previously used by the user, based on stored vehicle use history information related to the user.

12. The method of claim 11, wherein the vehicle use history information related to the user includes:
at least one of user identification information, a use date, a vehicle number, a vehicle type, and a vehicle handling history.

13. The method of claim 12, wherein the vehicle handling history includes:
at least one piece of vehicle handling information including a vehicle function, an operator type, an operator position, and an operator handling manner.

14. The method of claim 13, wherein the vehicle handling information is implemented with a vector value of each function defined based on the operator position.

15. The method of claim 13, wherein the vehicle handling information is implemented with a vector value of each function defined based on the operator handling manner.

16. The method of claim 13, wherein the recommending of the vehicle includes:
creating, by the vehicle sharing service apparatus, user function handling information by clustering vehicle handling information associated with at least one function used in the vehicle previously used by the user, based on the stored vehicle use history information related to the user;
comparing, by the vehicle sharing service apparatus, created user function handling information with function handling information related to each vehicle, which is previously stored to generate a comparison result; and
recommending, by the vehicle sharing service apparatus, at least one vehicle based on the comparison result.

17. The method of claim 16, wherein the comparing of created user function handling information with function handling information related to each vehicle, which is previously stored includes:
determining, by the vehicle sharing service apparatus, similarity between the created user function handling information and the function handling information related to each vehicle, which is previously stored, by adjusting a weight of each function based on at least one of use frequency of each function by the user or environment information related to each function.

18. The method of claim 17, wherein the recommending of the at least one vehicle includes:
recommending, by the vehicle sharing service apparatus, a vehicle mapped to vehicle function handling information having the similarity equal to or greater than a predetermined threshold value.

19. The method of claim 16, further including:
selecting, by the vehicle sharing service apparatus, one vehicle among recommended at least one vehicle to form a reservation for the one vehicle;
extracting, by the vehicle sharing service apparatus, different vehicle function handling information related to a difference between the function handling information related to the one vehicle subject to the reservation and the created user function handling information; and
creating, by the vehicle sharing service apparatus, a user customized manual based on extracted different vehicle function handling information to transmit created user customized manual to the vehicle terminal, after the recommending of the at least one vehicle based on the comparison result.

20. The method of claim 19, wherein the vehicle terminal outputs a tip for a function handling manner different from the function handling manner of the vehicle, which is previously used by the user, based on the created user customized manual, when the user is detected to get on the one vehicle.
